(19) United States
(12) Patent Application Publication
(10) Pub. No.: US 2010/0079454 A1
(43) Pub. Date: Apr. 1, 2010

(54) Single Pass Tessellation

(76) Inventors: Justin S. Legakis, Sunnyvale, CA (US); Emmett M. Kilgariff, San Jose, CA (US); Henry Packard Moreton, Woodside, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/240,382

(22) Filed: Sep. 29, 2008

(51) Int. Cl. G06T 17/20

(52) U.S. Cl. 345/423

(57) ABSTRACT

A system and method for performing tessellation in a single pass through a graphics processor divides the processing resources within the graphics processor into sets for performing different tessellation operations. Vertex data and tessellation parameters are routed directly from one processing resource to another instead of being stored in memory. Therefore, a surface patch description is provided to the graphics processor and tessellation is completed in a single uninterrupted pass through the graphics processor without storing intermediate data in memory.

### BACKGROUND OF THE INVENTION

1. Field of the Invention

The present invention generally relates to tessellation of three-dimensional surface patches and more specifically to performing tessellation in a single pass through a graphics processing pipeline.

2. Description of the Related Art

The programming model for tessellation hardware has evolved to expose new shader programs that are executed to perform tessellation of three-dimensional surface patches. Conventional hardware architectures use a two pass approach to perform tessellation. During a first pass through a graphics processing pipeline vertex shader and tessellation control shader (or control hull shader) programs are executed and vertex data and tessellation parameters are stored in memory. After the first pass is complete, the graphics processing pipeline is reconfigured. During a second pass through the graphics processing pipeline, the vertex data and tessellation parameters are read from memory and tessellation evaluation shader (or domain shader) and geometry shader programs are executed to complete the tessellation operation. Typically, a software application program or device driver initiates both the first pass and the second pass.

Accordingly, what is needed in the art is an improved system and method for executing tessellation shader programs.

### SUMMARY OF THE INVENTION

A system and method for performing tessellation in a single pass through a graphics processor divides the processing resources within the graphics processor into sets for performing different tessellation operations. Vertex data and tessellation parameters are routed directly from one processing resource to another instead of being stored in memory. Therefore, a surface patch description is provided to the graphics processor and tessellation is completed in a single uninterrupted pass through the graphics processor without storing intermediate data in memory.

Various embodiments of a method of the invention for performing tessellation in a single pass through a graphics processor include configuring a first set of processing units of the graphics processor and configuring a second set of the processing units within the graphics processor. The first set of processing units are configured to execute a tessellation control shader to process surface patches, computing tessellation level of details and producing a graphics primitive including multiple vertices. The second set of the processing units are configured to execute a tessellation evaluation shader to each process one of the multiple vertices. The tessellation control shader and the tessellation evaluation shader are then executed to tessellate the surface patches in a single pass through the first set of processing units and the second set of processing units to produce processed vertices.

Various embodiments of the invention include a system for performing tessellation in a single pass through a graphics processor. The graphics processor includes a first set of processing units, a second set of processing units, and a crossbar interconnect. The first set of processing units are configured to execute a tessellation control shader to process surface patches and produce a graphics primitive including multiple vertices. The second set of the processing units are configured to execute a tessellation evaluation shader to each process one of the multiple vertices. The crossbar interconnect is coupled to the first set of processing units and the second set of processing units and configured to route the multiple vertices output by the first set of processing units to inputs of the second set of the processing units.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3A is a block diagram of a GPC within one of the PPUs of FIG. 2, according to one embodiment of the present invention;

FIG. 3B is a block diagram of a partition unit within one of the PPUs of FIG. 2, according to one embodiment of the present invention;

FIG. 4 is a conceptual diagram of a graphics processing pipeline that one or more of the PPUs of FIG. 2 can be configured to implement, according to one embodiment of the present invention;

FIG. 5A is a flow diagram of method steps for performing tessellation in a single pass, according to one embodiment of the present invention; and

FIG. 5B is a block diagram of a GPC configured to perform tessellation in a single pass, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

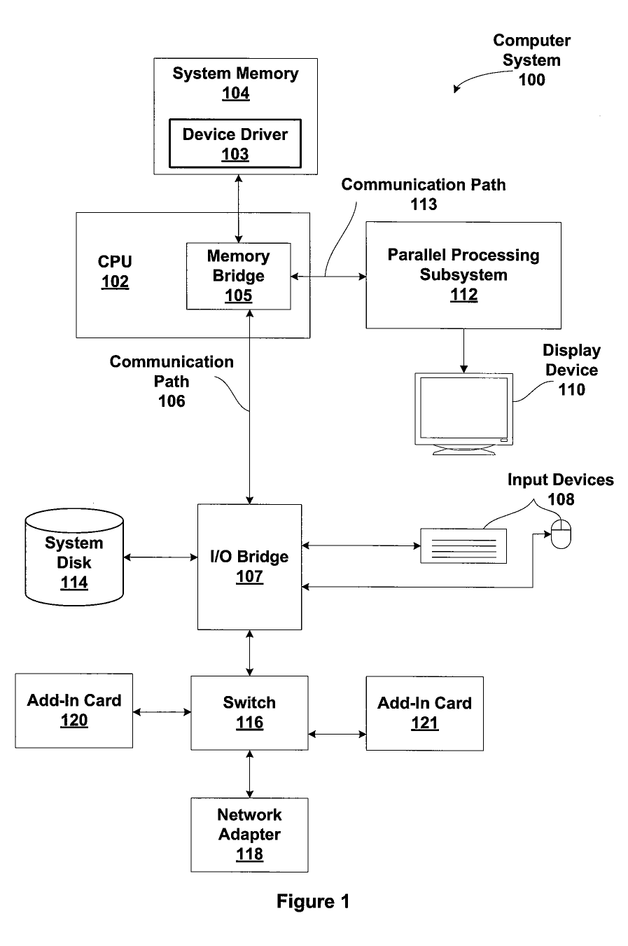

FIG. 1 is a block diagram illustrating a computer system 100 configured to implement one or more aspects of the present invention. Computer system 100 includes a central processing unit (CPU) 102 and a system memory 104 communicating via a bus path through a memory bridge 105. Memory bridge 105 may be integrated into CPU 102 as shown in FIG. 1. Alternatively, memory bridge 105, may be a conventional device, e.g., a Northbridge chip, that is connected via a bus to CPU 102. Memory bridge 105 is connected via communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, one or more of CPU 102, I/O bridge 107, parallel processing subsystem 112, and memory bridge 105 are integrated into one or more chips. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

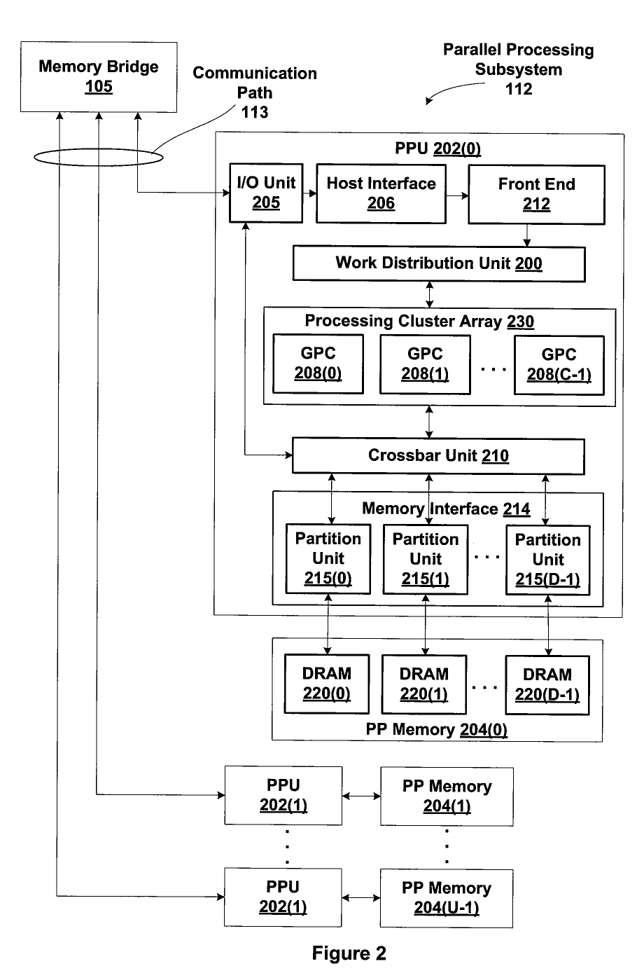

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various tasks related to generating pixel data from graphics data supplied by CPU 102 and/or system memory 104, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a command buffer (not explicitly shown in either FIG. 1 or FIG. 2) that may be located in system memory 104, parallel processing memory 204, or another storage location accessible to both CPU 102 and PPU 202. PPU 202 reads the command stream from the command buffer and then executes commands asynchronously relative to the operation of CPU 102. CPU 102 may also create data buffers, which PPUs 202 may read in response to commands in the command buffer. Each command and data buffer may be read by multiple PPUs 202.

Referring back now to FIG. 2, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI-E link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each command buffer and outputs the work specified by the command buffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform tessellation operations and to produce primitive topologies for patches, and a second set of GPCs 208 may be allocated to perform tessellation shading to evaluate patch parameters for the primitive topologies and to determine vertex positions and other per-vertex attributes. The allocation of GPCs 208 may vary dependent on the workload arising for each type of program or computation. Alternatively, all GPCs 208 may be allocated to perform processing tasks using time-slice scheme to switch between different processing tasks.

GPCs 208 receive processing tasks to be executed via a work distribution unit 200, which receives commands defining processing tasks from front end unit 212. Processing tasks include pointers to data to be processed, e.g., surface (patch) data, primitive data, vertex data, and/or pixel data, as well as state parameters and commands defining how the data is to be processed (e.g., what program is to be executed). Work distribution unit 200 may be configured to fetch the pointers corresponding to the tasks, work distribution unit 200 may receive the pointers from front end 212, or work distribution unit 200 may receive the data directly. In some embodiments of the present invention, indices specify the location of the data in an array. Front end 212 ensures that GPCs 208 are configured to a valid state before the processing specified by the command buffers is initiated.

When PPU 202 is used for graphics processing, for example, the processing workload for each patch is divided into approximately equal sized tasks to enable distribution of the tessellation processing to multiple GPCs 208. A work distribution unit 200 may be configured to output tasks at a frequency capable of providing tasks to multiple GPCs 208 for processing. In some embodiments of the present invention, portions of GPCs 208 are configured to perform different types of processing. For example a first portion may be configured to perform vertex shading and topology generation, a second portion may be configured to perform tessellation and geometry shading, and a third portion may be configured to perform pixel shading in screen space to produce a rendered image. The ability to allocate portions of GPCs 208 for performing different types of processing efficiently accommodates any expansion and contraction of data produced by the different types of processing. Intermediate data produced by GPCs 208 may buffered to allow the intermediate data to be transmitted between GPCs 208 with minimal stalling when a rate at which data is accepted by a downstream GPC 208 lags the rate at which data is produced by an upstream GPC 208.

Memory interface 214 may be partitioned into a number D of memory partition units that are each directly coupled to a portion of parallel processing memory 204, where D≧1. Each portion of memory generally consists of one or more memory devices (e.g DRAM 220). Persons skilled in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the partition units 215 within parallel processing memory 204. Crossbar unit 210 is configured to route the output of each GPC 208 to the input of any partition unit 214 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI-E) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Processing Cluster Array Overview

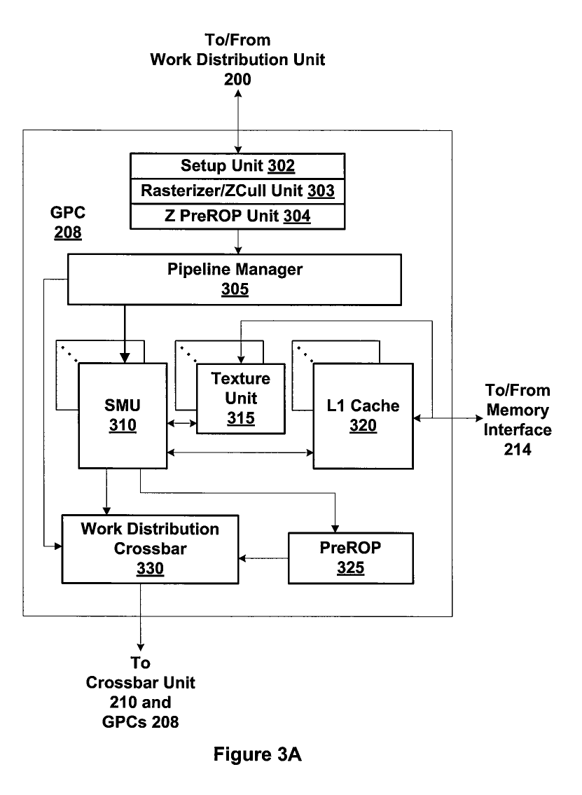

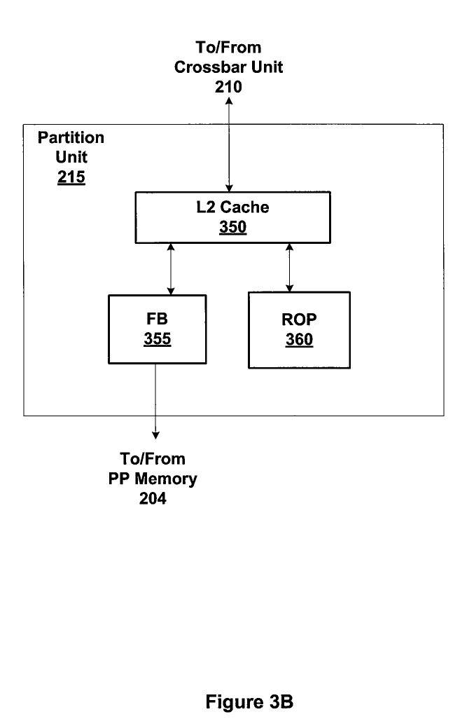

FIG. 3A is a block diagram of a GPC 208 within one of the PPUs 202 of FIG. 2, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

In graphics applications, a GPC 208 may be configured to include a primitive engine for performing screen space graphics processing functions that may include, but are not limited to primitive setup, rasterization, and z culling. As shown in FIG. 3A, a setup unit 302 receives instructions for processing graphics primitives and reads graphics primitive parameters from buffers. The buffers may be stored in L1 caches 315, partition units 215, or PP memory 204. A rasterizer/zcull unit 303 receives the graphics primitive parameters and rasterizes primitives that intersect pixels that are assigned to the rasterizer/zcull unit 303. Each pixel is assigned to only one of the rasterizer/zcull units 303, so portions of graphics primitives intersecting pixels that are not assigned to the rasterizer/zcull unit 303 are discarded. Rasterizer/zcull unit 303 also performs z culling to remove portions of graphics primitives that are not visible. A z preROP unit 304 performs address translations for accessing z data and maintains ordering for z data based on various z processing modes.

Operation of GPC 208 is advantageously controlled via a pipeline manager 305 that distributes processing tasks received from work distribution unit 200 (via setup unit 302, rasterizer/zcull unit 303, and z preROP unit 304) to streaming multiprocessor units (SMUs) 310. Pipeline manager 305 may also be configured to control a work distribution crossbar 330 by specifying destinations for processed data output by SMUs 310.

In one embodiment, each GPC 208 includes a number M of SMUs 310, where M≧1, each SMU 310 configured to process one or more thread groups. Also, each SMU 310 advantageously includes an identical set of functional units (e.g., arithmetic logic units, etc.) that may be pipelined, allowing a new instruction to be issued before a previous instruction has finished, as is known in the art. Any combination of functional units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional-unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SMU 310 is referred to herein as a “thread group.” As used herein, a “thread group” refers to a group of threads concurrently executing the same program on different input data, with each thread of the group being assigned to a different processing engine within an SMU 310. A thread group may include fewer threads than the number of processing engines within the SMU 310, in which case some processing engines will be idle during cycles when that thread group is being processed. A thread group may also include more threads than the number of processing engines within the SMU 310, in which case processing will take place over multiple clock cycles. Since each SMU 310 can support up to G thread groups concurrently, it follows that up to G×M thread groups can be executing in GPC 208 at any given time.

Additionally, a plurality of related thread groups may be active (in different phases of execution) at the same time within an SMU 310. This collection of thread groups is referred to herein as a “cooperative thread array” (“CTA”). The size of a particular CTA is equal to m*k, where k is the number of concurrently executing threads in a thread group and is typically an integer multiple of the number of parallel processing engines within the SMU 310, and m is the number of thread groups simultaneously active within the SMU 310. The size of a CTA is generally determined by the programmer and the amount of hardware resources, such as memory or registers, available to the CTA.

An exclusive local address space is available to each thread and a shared per-CTA address space is used to pass data between threads within a CTA. Data stored in the per-thread local address space and per-CTA address space is stored in L1 cache 320 and an eviction policy may be used to favor keeping the data in L1 cache 320. Each SMU 310 uses space in a corresponding L1 cache 320 that is used to perform load and store operations. Each SMU 310 also has access to L2 caches within the partition units 215 that are shared among all GPCs 208 and may be used to transfer data between threads. Finally, SMUs 310 also have access to off-chip “global” memory, which can include, e.g., parallel processing memory 204 and/or system memory 104. An L2 cache may be used to store data that is written to and read from global memory. It is to be understood that any memory external to PPU 202 may be used as global memory.

In graphics applications, a GPC 208 may be configured such that each SMU 310 is coupled to a texture unit 315 for performing texture mapping operations, e.g., determining texture sample positions, reading texture data, and filtering the texture data. Texture data is read via memory interface 214 and is fetched from an L2 cache, parallel processing memory 204, or system memory 104, as needed. Texture unit 315 may be configured to store the texture data in an internal cache. In some embodiments, texture unit 315 is coupled to L1 cache 320 and texture data is stored in L1 cache 320. Each SMU 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SMU 310, direct data to ROP units within partition units 215, and perform optimizations for color blending, organize pixel color data, and perform address translations.

It will be appreciated that the core architecture described herein is illustrative and that variations and modifications are possible. Any number of processing engines, e.g., SMUs 310, texture units 315, or preROPs 325 may be included within a GPC 208. Further, while only one GPC 208 is shown, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing engines, L1 caches 320, and so on.

FIG. 3B is a block diagram of a partition unit 215 within on of the PPUs 202 of FIG. 2, according to one embodiment of the present invention. As shown, partition unit 215 includes a L2 cache 350, a frame buffer (FB) 355, and a raster operations unit (ROP) 360. L2 cache 350 is a read/write cache that is configured to perform load and store operations received from crossbar unit 210 and ROP 360. Read misses and urgent writeback requests are output by L2 cache 350 to FB 355 for processing. Dirty updates are also sent to FB 355 for opportunistic processing. FB 355 interfaces directly with parallel processing memory 204, outputting read and write requests and receiving data read from parallel processing memory 204.

In graphics applications, ROP 360 is a processing unit that performs raster operations, such as stencil, z test, blending, and the like, and outputs pixel data as processed graphics data for storage in graphics memory. In some embodiments of the present invention, ROP 360 is included within each GPC 208 instead of each partition unit 215, and pixel reads and writes are transmitted over crossbar unit 210 instead of pixel fragment.

The processed graphics data may be displayed on display device 110 or routed for further processing by CPU 102 or by one of the processing entities within parallel processing subsystem 112. Each partition unit 215 includes a ROP 360 in order to distribute processing of the raster operations. In some embodiments, ROP 360 may be configured to compress z or color data that is written to memory and decompress z or color data that is read from memory.

Persons skilled in the art will understand that the architecture described in FIGS. 1, 2, 3A and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

### Graphics Pipeline Architecture

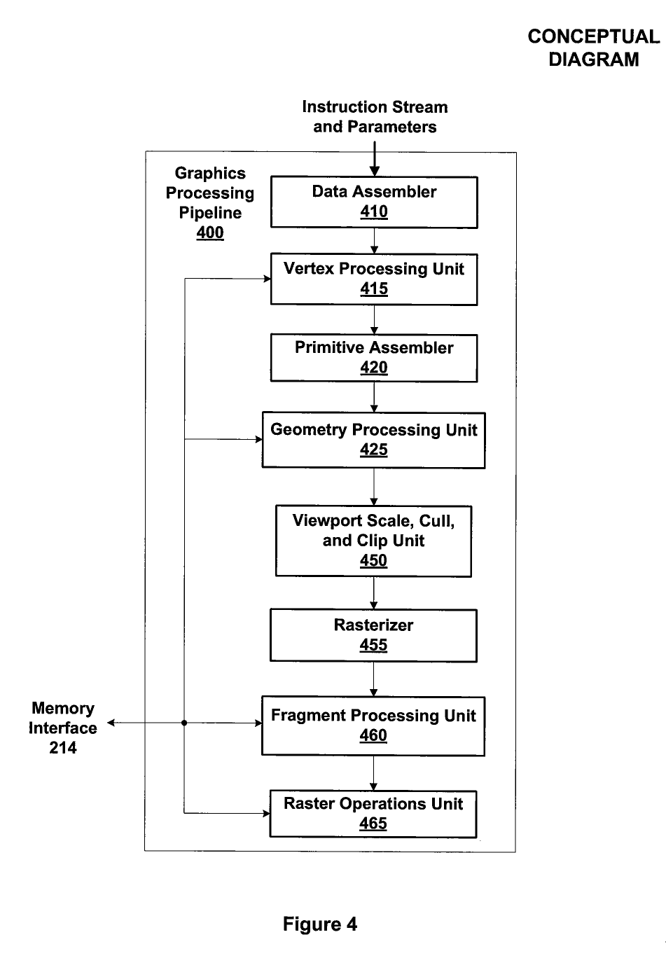

FIG. 4 is a conceptual diagram of a graphics processing pipeline 400, that one or more of the PPUs 202 of FIG. 2 can be configured to implement, according to one embodiment of the present invention. For example, one of the SMUs 310 may be configured to perform the functions of one or more of a vertex processing unit 415, a geometry processing unit 425, and a fragment processing unit 460. The functions of data assembler 410, primitive assembler 420, rasterizer 455, and raster operations unit 465 may also be performed by other processing engines within a GPC 208 and a corresponding partition unit 215. Alternately, graphics processing pipeline 400 may be implemented using dedicated processing units for one or more functions.

Data assembler 410 processing unit collects vertex data for high-order surfaces, primitives, and the like, and outputs the vertex data, including the vertex attributes, to vertex processing unit 415. Vertex processing unit 415 is a programmable execution unit that is configured to execute vertex shader programs, lighting and transforming vertex data as specified by the vertex shader programs. For example, vertex processing unit 415 may be programmed to transform the vertex data from an object-based coordinate representation (object space) to an alternatively based coordinate system such as world space or normalized device coordinates (NDC) space. Vertex processing unit 415 may read data that is stored in L1 cache 320, parallel processing memory 204, or system memory 104 by data assembler 410 for use in processing the vertex data.

Primitive assembler 420 receives vertex attributes from vertex processing unit 415, reading stored vertex attributes, as needed, and constructs graphics primitives for processing by geometry processing unit 425. Graphics primitives include triangles, line segments, points, and the like. Geometry processing unit 425 is a programmable execution unit that is configured to execute geometry shader programs, transforming graphics primitives received from primitive assembler 420 as specified by the geometry shader programs. For example, geometry processing unit 425 may be programmed to subdivide the graphics primitives into one or more new graphics primitives and calculate parameters, such as plane equation coefficients, that are used to rasterize the new graphics primitives.

In some embodiments, geometry processing unit 425 may also add or delete elements in the geometry stream. Geometry processing unit 425 outputs the parameters and vertices specifying new graphics primitives to a viewport scale, cull, and clip unit 450. Geometry processing unit 425 may read data that is stored in parallel processing memory 204 or system memory 104 for use in processing the geometry data. Viewport scale, cull, and clip unit 450 performs clipping, culling, and viewport scaling and outputs processed graphics primitives to a rasterizer 455.

Rasterizer 455 scan converts the new graphics primitives and outputs fragments and coverage data to fragment processing unit 460. Additionally, rasterizer 455 may be configured to perform z culling and other z-based optimizations. Fragment processing unit 460 is a programmable execution unit that is configured to execute fragment shader programs, transforming fragments received from rasterizer 455, as specified by the fragment shader programs. For example, fragment processing unit 460 may be programmed to perform operations such as perspective correction, texture mapping, shading, blending, and the like, to produce shaded fragments that are output to raster operations unit 465. Fragment processing unit 460 may read data that is stored in parallel processing memory 204 or system memory 104 for use in processing the fragment data. Fragments may be shaded at pixel, sample, or other granularity, depending on the programmed sampling rate.

Raster operations unit 465 is a processing unit that performs raster operations, such as stencil, z test, blending, and the like, and outputs pixel data as processed graphics data for storage in graphics memory. The processed graphics data may be stored in graphics memory, e.g., parallel processing memory 204, and/or system memory 104, for display on display device 110 or for further processing by CPU 102 or parallel processing subsystem 112. In some embodiments of the present invention, raster operations unit 465 is configured to compress z or color data that is written to memory and decompress z or color data that is read from memory.

### Single Pass Tessellation

In order to perform tessellation in a single pass, a first portion of SMUs 310 are configured to execute tessellation control shader programs and a second portion of SMUs 310 are configured to execute tessellation evaluation shader programs. The first portion of SMUs 310 receive surface patch descriptions and output graphics primitives, such as cubic triangle primitives defined by ten control points, and tessellation parameters such as level of detail values. Graphics primitives and tessellation parameters are routed from one SMU 310 to another through L1 cache 320 and work distribution crossbar 330 instead of being stored in PP memory 204. Therefore, tessellation of a surface patch description is completed in a single uninterrupted pass through GPC 208 without storing intermediate data in L2 cache 350 or PP memory 204. Additionally, an application program or device driver 103 provides the surface patch description and does not reconfigure portions of GPC 208 during the tessellation processing.

The number of SMUs 310 in the first portion may be equal, greater than, or less than the number of SMUs 310 in the second portion. Importantly, the number of SMUs 310 in the first and second portions can be tailored to match the processing workload. The number of vertices produced by a single surface patch varies with the computed tessellation level of detail. Therefore, a single SMP 310 in the first portion of SMUs 310 may produce “work” for multiple SMPs 310 in the second portion of SMUs 310 since execution of a tessellation control shader program may result in a data expansion.

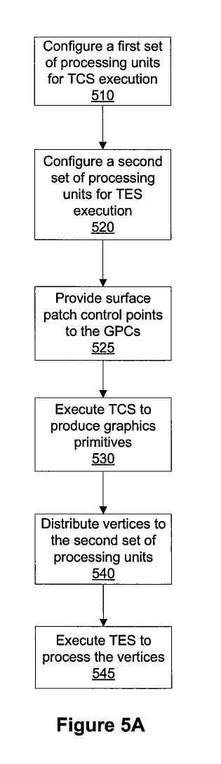

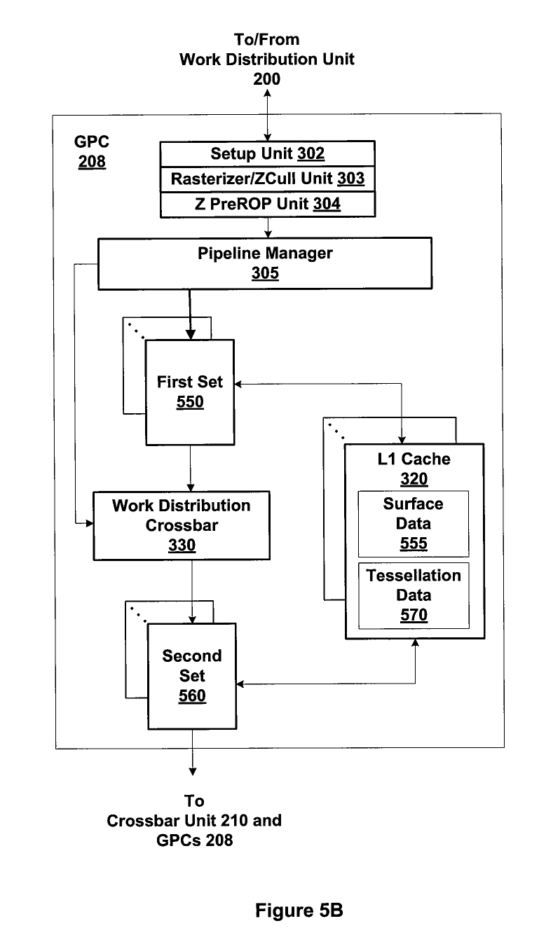

FIG. 5A is a flow diagram of method steps for performing tessellation in a single pass, according to one embodiment of the present invention. In step 510 device driver 103 configures a first set of SMUs 310 for tessellation control shader program execution. A tessellation control shader program may perform a change of basis of a control point, computation of tessellation level of detail parameters, or the like, and is executed once for each surface patch. A change of basis of a patch occurs when a tessellation control shader program inputs one patch (set of control points) and outputs a different patch (a different set of control points), where the number of control points varies between the input patch and the output patch. In step 520 device driver 103 configures a second set of SMUs 310 for tessellation evaluation program execution. A tessellation evaluation control shader program may compute a final position and attributes of each vertex based on the patch primitive control points, a parametric (u,v) position for each vertex, displacement maps, and the like, and is executed once for each output vertex.

In step 520 device driver 103 configures SMUs 310 into a first set and a second set and downloads the tessellation control shader and tessellation evaluation shader programs that are executed by GPCs 208 to process the surface data and produce output vertices. In step 530 SMUs 310 in the first set of SMUs 310 execute the tessellation control shader program to produce graphics primitives, e.g., control points for graphics primitives such as cubic triangles.

In step 540 vertices of the graphics primitives output by the first set of SMUs 310 are distributed to the inputs of the second set of SMUs 310. In step 545 SMUs 310 in the second set of SMUs 310 execute the tessellation evaluation shader program to produce output vertices. Note, that for different vertices, steps 530, 540, and 545 occur at different times. Therefore, as the graphics primitives are output by SMUs 310 in the first set, SMUs 310 in the second set begin execution of the tessellation evaluation programs to produce output vertices. Because SMUs 310 are configured to process the surface patches in a single pass, device driver 103 is not needed to reconfigure SMUs 310 to perform different operations during the tessellation operations.

FIG. 5B is a block diagram of GPC 208 that is configured to perform tessellation in a single pass, according to one embodiment of the present invention. A first set 550 is a first set of SMUs 310 that is configured to execute tessellation control shader programs. A second set 560 is a second set of SMUs 310 that is configured to execute tessellation evaluation shader programs. First set 550, work distribution crossbar 330, and second set 560 may be configured to perform steps 530, 540, and 545 of FIG. 5A. Work distribution crossbar 330 is configured to connect each SMU 310 in first set 550 to each SMU 310 in second set 560.

Surface data 555, representing the surface patches may be stored in L1 cache 320, as shown in FIG. 5B, and read by first set 550. Pipeline manager 305 may be configured to provide locations of surface data 555 to each SMU 310 in first set 550 to distribute the surface patches for processing. Tessellation data 570, representing the graphics primitives output by first set 550 may be stored in L1 cache 320. Pipeline manager 305 provides work distribution crossbar 330 routing information that is needed to distribute graphics primitive vertices to the inputs of SMUs 310 in second set 560. In some embodiments of the present invention, such as the embodiment shown in FIG. 5B, tessellation data 570 is routed through work distribution crossbar 330. In other embodiments of the present invention, indices corresponding to the location of each graphics primitive vertex are routed through work distribution crossbar 330 to distribute tessellation data 570 output by first set 550 to the inputs of second set 560. Importantly, tessellation data 570 is stored in L1 cache 320 or L2 cache 350 rather than being stored PP memory 204, reducing the number of clock cycles needed to read and write tessellation data 570.

As SMUs 310 in first set 550 write tessellation data 570, SMUs 310 in second set 560 read tessellation data 570, so the amount of storage consumed by tessellation data 570 is reduced to fit within L1 cache 320 or L2 cache 350. In contrast, in a conventional system, when two different passes are used to execute the programs, all of the data produced by tessellation control shader program for a group of patches is stored in off chip memory, e.g., PP memory 204, before the pipeline is configured to execute tessellation evaluation shader program and read the data. Additionally, when a conventional two pass technique is used, the number of patches in a group is typically large to reduce the frequency of pipeline reconfigurations incurred to switch between executing the tessellation control shader program and the tessellation evaluation shader program. The tessellation data produced by processing the larger number of patches in the first pass requires more storage than tessellation data 570, and is therefore stored in off chip memory.

As described in conjunction with FIGS. 5A and 5B, tessellation of a surface patch description is completed in a single uninterrupted pass through GPC 208 without storing intermediate data in PP memory 204. Additionally, an application program or device driver 103 provides the surface patch description and does not reconfigure portions of GPC 208 during the tessellation processing. An application programmer may advantageously view PPU 202 as a single tessellation pipeline that is automatically configured to process surfaces in a single pass.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A method for performing tessellation in a single pass through a graphics processor, the method comprising:
configuring a first set of processing units of the graphics processor to execute a tessellation control shader to process surface patches and produce a graphics primitive including multiple vertices;
configuring a second set of the processing units within the graphics processor to execute a tessellation evaluation shader to each process one of the multiple vertices; and
executing the tessellation control shader and the tessellation evaluation shader to tessellate the surface patches in a single pass through the first set of processing units and the second set of processing units to produce processed vertices.

2. The method of claim 1, further comprising the step of distributing the multiple vertices output by the first set of the processing units to inputs of the second set of the processing units.

3. The method of claim 2, wherein the step of distributing comprises routing indices corresponding to a location storing each of the multiple vertices from the first set of the processing units to inputs of the second set of the processing units.

4. The method of claim 1, wherein the tessellation control shader is executed once for each one of the surface patches to compute level of detail parameters for the one surface patch.

5. The method of claim 1, wherein the tessellation evaluation shader is executed once for each one of the multiple vertices to compute a final position and attributes of the one vertex.

6. The method of claim 1, wherein the number of processing units in the first set of the processing units is greater than the number of processing units in the second set of the processing units.

7. The method of claim 1, wherein the number of processing units in the first set of the processing units is less than the number of processing units in the second set of the processing units.

8. The method of claim 1, wherein the number of processing units in the first set of the processing units equals the number of processing units in the second set of the processing units.

9. The method of claim 1, wherein each one of the processing units executes the tessellation control shader or the tessellation evaluation shader independent of the other processing units.

10. The method of claim 1, wherein the graphics primitive is a cubic patch specified by ten vertices.

11. A system for performing tessellation in a single pass, comprising:
a graphics processor including:
a first set of processing units that are configured to execute a tessellation control shader to process surface patches and produce a graphics primitive including multiple vertices;
a second set of the processing units configured to execute a tessellation evaluation shader to each process one of the multiple vertices; and
a crossbar interconnect coupled to the first set of processing units and the second set of processing units and configured to provide the multiple vertices output by the first set of processing units to inputs of the second set of the processing units.

12. The system of claim 11, wherein the tessellation control shader is executed once for each one of the surface patches to compute level of detail parameters for the one surface patch.

13. The system of claim 11, wherein the tessellation evaluation shader is executed once for each one of the multiple vertices to compute a final position and attributes of the one vertex.

14. The system of claim 11, wherein the processing units are configured to execute the tessellation control shader and the tessellation evaluation shader to tessellate the surface patches in a single pass.

15. The system of claim 11, wherein the number of processing units in the first set of the processing units is greater than the number of processing units in the second set of the processing units.

16. The system of claim 11, wherein the number of processing units in the first set of the processing units is less than the number of processing units in the second set of the processing units.

17. The system of claim 11, wherein the number of processing units in the first set of the processing units equals the number of processing units in the second set of the processing units.

18. The system of claim 11, wherein each one of the processing units executes the tessellation control shader or the tessellation evaluation shader independent of the other processing units.

19. The system of claim 11, wherein the graphics primitive is a cubic patch specified by ten vertices.

20. The system of claim 11, wherein the crossbar interconnect is configured to route indices corresponding to locations of the multiple vertices in a cache to provide the multiple vertices output by the first set of processing units to inputs of the second set of the processing units.
